(19) United States
(12) Patent Application Publication
(10) Pub. No.: US 2004/0002382 A1
(43) Pub. Date: Jan. 1, 2004

(54) Method enabling mobile telephone game playing capability on wireless networks

(75) Inventors: David Ho, Taipei Hsieng (TW); Jie Lin, Shanghai City (CN)

Correspondence Address: BACON & THOMAS, PLLC, 625 SLATERS LANE, FOURTH FLOOR, ALEXANDRIA, VA, 22314

(73) Assignee: Inventec Appliances Corp., Taipei Hsieng (TW)

(21) Appl. No.: 10/180,514

(22) Filed: Jun. 27, 2002

(51) Int. Cl. G06F 17/00

(52) U.S. Cl. 463/41

(57) ABSTRACT

This invention is to provide a method established between a server and at least one mobile telephone through a network, wherein the said mobile telephone(s) consists of a unit having an installed network communications device and game software such that after the said server receives the game data transferred from each said mobile telephone, the processing of the said game data is executed to generate updated data. The said server then transfers the said updated data to each said mobile telephone such that the central processing unit thereof utilizes the said game software to commensurately execute the processing of the said updated files and display a new game operating menu on the screens thereof, thereby enabling the said mobile telephones to execute game play on wireless networks.

### BACKGROUND OF THE INVENTION

1) Field of the Invention

The invention herein relates to a method enabling mobile telephone game playing capability on wireless networks.

2) Description of the Prior Art

As technology advances, numerous innovative and different function software have been invented, including on-line games. Since on-line game software are now mainstream applications, with network game development companies continually developing various new on-line network games at lightning speed and in prolific quantity now occupying a viable market position. Furthermore, the unbelievable power of on-line games are attracting an increasing number of users.

The arrangement adopted by the majority of on-line games consists of computer and game consoles having installed game software capable of exquisite graphics, menus, and realistic audio. Equipped with network communications devices, the said computers and game consoles are connected to remote terminal servers, the said remote terminal servers handling the processing of data exchanges that are input by each computer and game console.

Many currently available mobile telephones have installed game software or new games can be downloaded to the said mobile telephones via a network to provide for user recreation. Some mobile telephones have built-in infrared devices such that after two mobile telephone infrared devices are mutually aligned, the two-way signal transmission achieved enables game play execution.

However, since the said mobile telephone infrared devices require mutual alignment before two-way signal transmission is possible, when such handheld mobile telephones are moved due to the operation of their inputting components as a game is being played, the alignment of the said infrared devices cannot be maintained, which interrupts the signal and halts the game.

Moreover, the transmission bandwidth of the said infrared devices is relatively narrow and even hardwired transmission approaches allows the connection of the said mobile telephones to only two handheld game consoles and simultaneous game playing by additional handheld game consoles is not possible, resulting in user annoyance and inconveniences which is contrary to the human entertainment objectives of the said amusement electronics. Therefore, mobile telephones capable of game play on wireless networks are urgently needed. Furthermore, since the functions of currently available mobile telephones are considerably expanded and most have built-in network communications devices, such mobile telephones should have wireless network game playing capacity to thereby provide mobile telephone users a greater product selection, while also presenting mobile telephone manufacturers unlimited business opportunities.

### SUMMARY OF THE INVENTION

In view of the fact that presently existent wireless network games can be configured to accommodate virtually all computers and most game consoles, but mobile telephones still have no wireless network game playing capability and the utilization of wireless transmission by the said mobile telephones to play games on wireless networks is certainly needed, the inventor of the invention herein conducted extensive research and experimentation that successfully culminated in the design of the method enabling mobile telephone game playing capability on wireless networks of the invention herein. The said method consists of the configuration between the remote terminal of a server and a minimum of one mobile telephone through a network and the said mobile telephone(s) consists of a unit having an installed network communications device and game software such that after the said server receives the game data transferred from each said mobile telephone, the processing of the said game data is executed to generate updated data. Next, the said server transfers the said updated data to each said mobile telephone such that the central processing unit of each said mobile telephone utilizes the said game software to commensurately execute the processing of the said updated files and a new game operating menu is displayed on the screens of the said mobile telephones, thereby enabling the said mobile telephones to execute game play on wireless networks.

The above and other objects, features and advantages of the present invention will become apparent from the following detailed description taken with the accompanying drawings.

### BRIEF DESCRIPTION OF THE DRAWINGS

FIG. 1 is a diagram of the server-to-mobile telephone transfer structure of the invention herein.

FIG. 2 is a flowchart of the invention herein illustrating signal transfers between the server and mobile telephones.

FIG. 3 is a flowchart of the invention herein illustrating signal transfers between the server and mobile telephones during the restart of game execution.

### DETAILED DESCRIPTION OF THE INVENTION

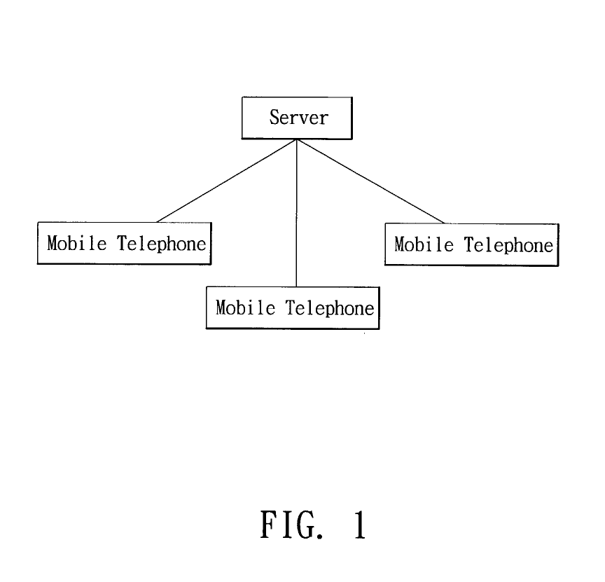

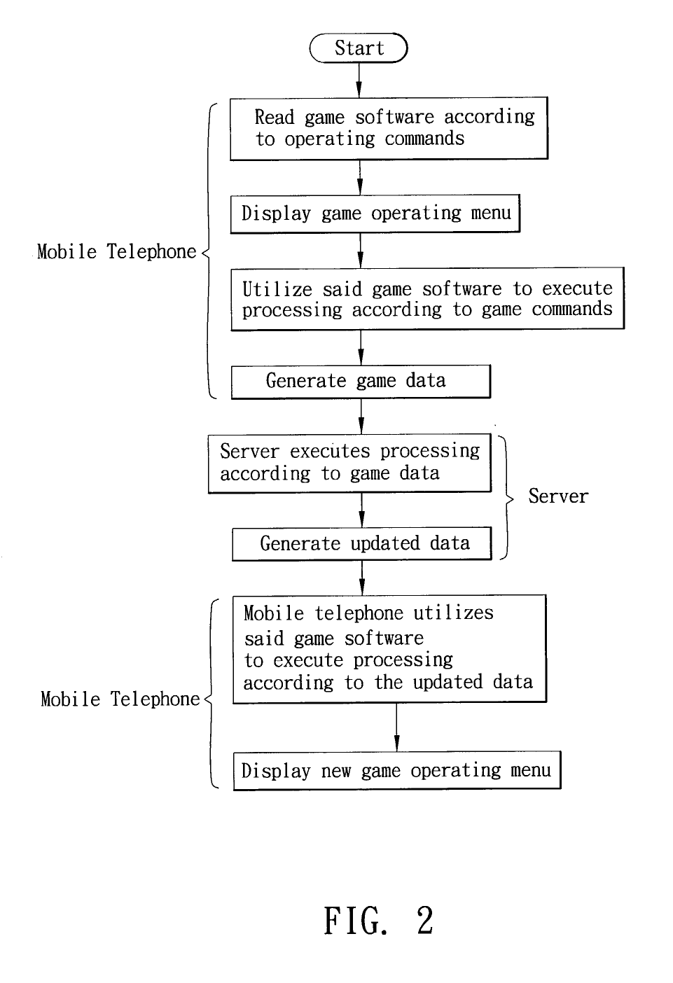

The invention herein is a method enabling mobile telephone game playing capability on wireless networks; referring to FIG. 1 and FIG. 2, the said method consists of a configuration between the remote terminal of a server and a minimum of one mobile telephone through a network; the said mobile telephone(s) consists of a unit having an installed network communications device and game software enabling the connection of the said mobile telephone(s) to the said server such that the central processing unit of the said mobile telephone(s) receives operating commands entered by inputting components (such as keys) on the said mobile telephone(s) and reads the said game software according to the. said operating commands, with the commensurate game operating menu of the said game software displayed on the screen of the said mobile telephone(s); game commands are then entered by the said inputting components and upon reception causes the execution and commensurate processing of the said game software according to the said game commands to generate game data, wherein:

The game data of the said mobile telephone(s) is transferred to the said server.

The said server executes processing to generate updated data corresponding to the said game(s) data.

The said server transfers the said updated data to each said mobile telephone.

The central processing unit of each said mobile telephone utilizes the said game software to execute the commensurate processing of the said updated data and displays a new game operating menu.

As such, all mobile telephones within the said network are connected to the said server via their built-in network communications devices, with the said server handling the game data processing of each said mobile telephone such that the said mobile telephone(s) synchronously receive the same updated data and generate identical new game operating menus, enabling the said mobile telephones to execute wireless network game playing.

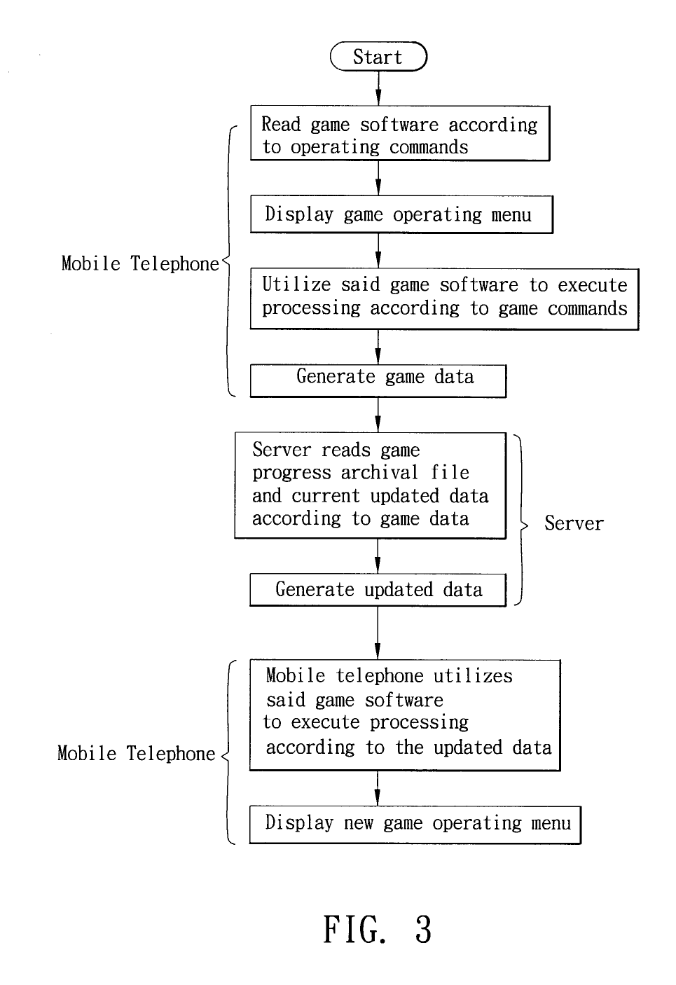

In the invention herein, referring to FIG. 3, a plurality of game progress archival files for the said game software are stored in the said server, the said game progress archival files retaining the progress content of each said mobile telephone before game conclusion such that when the said mobile telephones restart a said game, game data is inputted by the said mobile telephones into the said server, following which the said game progress archival files along with the current updated data of the server are first read, the commensurate processing is then executed based on the said game progress archival files and current updated data, after which updated data is generated; as such, each time a said mobile telephone restarts a said game, the progress content continues from the last game concluded and, therefore, whenever the said mobile telephone and server are re-connected anew, it is not necessary to replay game progress already completed, thereby saving game playing time and preventing the redundant and uninteresting execution of the same progress, thereby increasing game playability, competitiveness, and challenge levels.

Since conventional computers and game consoles are capable of game play over networks in real-time and with communications contact to enhance gaming pleasure, the invention herein enables the said mobile telephones to execute network game playing in real-time with communications contact such that when the said server executes the processing and generation of updated data according to the said game data, this also includes the real-time transfer of data, enabling the central processing unit in each said mobile telephone to utilize the said game software to execute the commensurate processing of the said updated data, following which the exchanged data is displayed in the said new game operating menu on the screens of the said mobile telephones.

However, while the said game is in the process of execution, all of the mobile telephones utilizing the said network may not be necessarily connected to the said network and, thus, data cannot be transferred to mobile telephones that are not linked to the network during game execution; as such, since data exchange between the said mobile telephones via the said server is effectively precluded, therefore, in the said embodiment, each said mobile telephone has a short message service (SMS) system, enabling each said mobile telephone to utilize the said SMS system in the said mobile telephones during game execution to convey data in abbreviated transfers to the mobile telephones that are not connected to the said network; as such, whether connected or not connected to a said server, the said mobile telephones(s) are capable of executing wireless network game playing with mutual contact between the said mobile telephones.

In the said embodiment, the said server automatically saves game progress content in the said game progress archival files of each said mobile telephone at preset intervals of time and, as such, after each said mobile telephone is disconnected from the said server and the said game is later restarted, the said server receives the game data inputted by each mobile telephone, following which the said game progress archival files along with the current updated data of the server are first read, processing is then executed based on the said game progress archival files and current updated data, after which updated data is generated and the execution of the game is continued, thereby preventing the starting the game at the progress content previous to disconnection because the results stored before game conclusion have not been fully deleted.

While the invention has been described by means of specific embodiments, numerous modifications and variations could be made thereto by those skilled in the art without departing from the scope and spirit of the invention set fort.

1. A method enabling mobile telephone game playing capability on wireless networks, the said method is to establish a configuration between a remote terminal of a server and at least one mobile telephone through a network, wherein the said mobile telephone(s) consists of a unit having an installed network communications device and game software enabling the connection of the said mobile telephone(s) to the said server via the said network communications device such that after the said server and the said mobile telephone(s) are connected together, execution occurs according to the following procedures:
first, the said server receiving program data inputted by the said mobile telephone(s), following which the said game data is processed to generate updated data;
the said server then transferring the said updated data to each said mobile telephone;
a central processing unit of each said mobile telephone then utilizing the said game software to execute a commensurate processing of the said updated data;
each said mobile telephone displaying a new game operating menu on a screen thereof.

2. A method enabling mobile telephone game playing capability on wireless networks as claimed in claim 1, in which after the said central processing unit of the said mobile telephone(s) receives operating commands entered by an inputting component on the said mobile telephone(s), the said central processing unit reads the said game software according to the said operating commands, displays the said game operating menu of the said game software on the said screen of the said mobile telephone(s), and then executes the said commensurate processing of the said game software according to the said game commands to generate game data after receiving the said game commands entered by the said inputting components.

3. A method enabling mobile telephone game playing capability on wireless networks as claimed in claim 1, in which a plurality of game progress archival files for the said game software are stored in the said server, the said game progress archival files retaining the progress content of each said mobile telephone before game conclusion such that when the said mobile telephones restart the said game, game data is inputted by the said mobile telephones into the said server, following which the said game progress archival files along with current updated data of the said server are first read, the commensurate processing is then executed, after which updated data is generated.

4. A method enabling mobile telephone game playing capability on wireless networks as claimed in claim 3, in which the said server automatically saves game progress content in the said game progress archival files of each said mobile telephone at preset intervals of time.

5. A method enabling mobile telephone game playing capability on wireless networks as claimed in claim 1, in which the said updated data includes the real-time transfer of data, enabling the said central processing unit in each said mobile telephone to utilize the said game software to execute the said commensurate processing of the said updated data, following which the exchanged data is displayed in the said new game operating menu on the said screens of the said mobile telephones.

6. A method enabling mobile telephone game playing capability on wireless networks as claimed in claim 1, in which each said mobile telephone has a short message service system, enabling each said mobile telephone to utilize the said short message service system in the said mobile telephones during game execution to convey data in abbreviated transfers to the said mobile telephones that are not linked to the said network.
